(19) United States
(12) Patent Application Publication
(10) Pub. No.: US 2026/0087174 A1
(43) Pub. Date: Mar. 26, 2026

(54) Risk-Aware Multi-Party Anonymization

(71) Applicant: Veil.AI Oy, Helsinki (FI)

(72) Inventors: Timo MIETTINEN, Helsinki (FI); Mehreen ALI, Helsinki (FI)

(21) Appl. No.: 19/303,443

(22) Filed: Aug. 19, 2025

(30) Foreign Application Priority Data
Aug. 19, 2024 (FI) 20246034

(51) Int. Cl. G06F 21/62

(52) U.S. Cl. CPC G06F 21/6254

(57) ABSTRACT

A method, apparatus, computer program and system are disclosed for multi-party data anonymization in a system containing a local node and a plurality of external nodes, including forming a first local anonymization model based on a first set of local data available to the local node at a first time; obtaining a first shared anonymization model; and adapting the first local anonymization model based on the first shared anonymization model, wherein the adapting of the first local anonymization model is subjected to verifying that the adapted first local anonymization model passes a risk assessment.

### TECHNICAL FIELD

The present disclosure generally relates to risk-aware multi-party anonymization. In particular, but not exclusively, the present disclosure relates to risk-verified adaptation of local anonymization models using a shared anonymization model in distributed systems.

### BACKGROUND

This section illustrates useful background information without admission of any technique described herein representative of the state of the art.

Anonymization is required, for example, for data that are not public and especially when the data are sensitive, such as health data and social security related data. Anonymization may include, among others, replacing identifiers with pseudonyms or by using synthetic data instead of actual data. However, anonymization hinders combining datasets from different parties in a multi-party system. In particular, current anonymization methods cannot guarantee compatibility of the datasets if the anonymization is performed prior to combining data from different sources. On the other hand, legislation and organizational security policies may prevent sharing sensitive data with external parties.

### SUMMARY

It has been identified that fragmented anonymized data may prevent detecting and analyzing of rare phenomena. For example, new illnesses that are too rare to detect in a dataset of a single party may become detectable in a combined larger dataset. This problem could be addressed by using a trusted operator who would input all the different datasets from respective parties and perform the anonymization. In such a case, it is possible to arrange the anonymization successfully so that re-identification risk is curbed while making use of a combined large data pool. For example, in a large pool, the re-identification is reduced already by increasing the number of persons involved. In practice, re-identification may occur through quasi-identifiers that together identify individuals: put together an unusual gender or age for a given profession with a particular hometown that is also unusual, and re-identification is certain. With a much larger pool, the same combination of quasi-identifiers results in a much greater number of matching individuals, possibly preventing re-identification.

Using a trusted operator avoids some problems that would otherwise hinder multi-party anonymization. The merging of different databases as such requires handling different data schemas, but on top of that, the handling of the anonymization related details can be centrally resolved. Instead, decentralized multi-party anonymization should be able to produce compatible anonymized data in the absence of central control.

Other reasons for producing larger anonymized datasets also exist, including a need to develop artificial intelligence models trained on greater datasets. Larger datasets address problems in AI training, such as accidental presence of actually non-correlated random or systematic errors that are present in some smaller datasets.

According to a first example aspect there is provided a method in a local node for a multi-party data anonymization system comprising the local node and a plurality of external nodes, comprising
forming a first local anonymization model based on a first set of local data available to the local node at a first time;
obtaining a first shared anonymization model; and
adapting the first local anonymization model based on the first shared anonymization model; wherein
the adapting of the first local anonymization model is subjected to verifying that the adapted first local anonymization model passes a risk assessment.

The risk assessment may comprise or be a re-identification risk assessment.

The method may further comprise providing a remote node with information describing the first local anonymization model for forming of the first shared anonymization model.

Advantageously, anonymization by different local nodes may be harmonized by providing a first shared anonymization model for use by different local nodes that may then adapt their own first local anonymization models.

The risk assessment may be performed with a risk assessment circuitry. The risk assessment circuitry may comprise at least one memory comprising computer executable program code and at least one processor configured to execute the program code and accordingly verify whether an anonymization model being tested would be prone to one or more risks, such as privacy risks, re-identification risks, data utility risks, compliance and regulatory risks, inference attack risks, or linkage risks.

The risk assessment may comprise verifying that the adapted first local anonymization model would prevent identification of individuals whose identities are being concealed by the anonymization.

The verifying that the adapted first local anonymization model passes a risk assessment may comprise computing based on the assessed anonymization model and a set of data being anonymized or statistical characteristics of such data set whether re-identification of individuals would be possible.

Re-identification of individuals may be deemed possible, if it is possible to determine a group of individuals smaller than a given minimum group size. The minimum group size may depend on a global policy. The minimum group size may depend on a secondary policy.

The minimum group size may be defined as a smaller one of those resulting from the global policy and the secondary policy.

The method may further comprise forming a second local anonymization model based on a second set of local data available to the local node at a second time that is after the first time. The forming of the second local anonymization model may be subjected to verifying that the second local anonymization model passes the risk assessment.

The method may further comprise providing a remote node with information describing the second local anonymization model for forming of the second shared anonymization model.

The first local anonymization model and the second local anonymization model may be provided to the same remote node. The remote node may be another local node.

Alternatively, the remote node may be an orchestrating node.

Advantageously, some or all local nodes may further develop their own first local anonymization models based on further (second sets of) local data that has become available to them. Some of such developments may still maintain compatibility with the shared anonymization model while perhaps addressing new risks of re-identification.

The method may further comprise sharing, with an external party, information describing the second local anonymization model for forming a second shared anonymization model based on at least the first shared anonymization model and the information describing the second local anonymization model.

Information describing any anonymization model may further comprise information describing the data for anonymization of which the anonymization model has been formed, such as statistical characteristics. The statistical characteristics may include any one or more of the following: measures of central tendency; measures of dispersion; distribution shape; percentiles or quartiles; frequency counts or proportions; correlation or association measures; and/or aggregated summaries. The measures of central tendency may comprise any one or more of a mean, median, and/or mode. The measures of dispersion may comprise any one or more of a range; variance; standard deviation; and/or interquartile range. The measures of distribution shape may comprise skewness and/or kurtosis. The correlation or association measures may comprise correlation coefficients for numeric variables. The correlation coefficients may comprise Pearson coefficients. The correlation coefficients may comprise Spearman coefficients for numeric variables. The correlation coefficients may comprise chi-square tests for categorical variables.

The information describing any anonymization model may comprise synthetic data. The synthetic data may be formed to replicate risks of actual data based on which the anonymization model is formed, but with made up information.

The data based on which any anonymization model is formed may comprise unstructured data such as text. The unstructured data may be anonymized using pseudonymization, in which an identifier is reversibly represented by another identifier. The unstructured data may be anonymized using lossy conversion such as generalization. In case of hierarchical data, the lossy conversion may comprise deletion of lower level classification information.

The unstructured data may be anonymized using redaction in which some information is wiped substituted with given characters or wiped out entirely.

The synthetic data may entirely substitute actual data with which the anonymization model has been formed. The synthetic data may comprise or be unstructured, such as textual data. The synthetic data may comprise or be structured, such as tabular data.

The method may further comprise sending to at least one of the external nodes information describing the first anonymization model. The first shared anonymization model may be based on the information describing the first anonymization model. The first shared anonymization model may be based on the information describing the first anonymization model, and information describing one or more other anonymization models by respective one of more other local nodes.

Advantageously, some or all local nodes may further develop the first shared anonymization model into a second shared anonymization model, for example, to better take into account increased data available to local nodes such that earlier risks of re-identification have been mitigated by increased number of individuals sharing given quasi-identifiers.

The local anonymization model may define how data shall be anonymized by the local node.

The local anonymization model may define a mechanism for anonymizing data according to the local anonymization model. The local anonymization model may be deterministic, optionally including use of randomization.

The mechanism for anonymizing data may define how the anonymization is performed, optionally comprising any of parameters, privacy criteria, transformation rules.

The shared anonymization model may define how data shall be anonymized by a plurality of local nodes after they adopt the shared anonymization model. The shared anonymization model may define a mechanism for anonymizing data according to the shared anonymization model.

The mechanism for anonymizing data may define how the anonymization is performed, optionally comprising any of parameters, privacy criteria, transformation rules.

The shared anonymization model may be deterministic, optionally including use of randomization.

The method may further comprise
obtaining a second shared anonymization model; and
adapting the first or second local anonymization model based on the second shared anonymization model.

Advantageously, by adapting the local anonymization model based on the second shared anonymization model that has been refined based on contributions of local nodes, a plurality of local nodes may improve and harmonize their local anonymization models so that anonymized datasets produced by different local nodes could be combinable.

The adapting of the local anonymization model may be subjected to verifying that the adapted local anonymization model passes the risk assessment.

The method may further comprise maintaining earlier versions of the shared anonymization model. The method may further comprise describing anonymized datasets with a version of a shared anonymization model that has been used for improving interoperability with other nodes.

The shared anonymization model may aggregate anonymization weights and parameters obtained from a plurality of local nodes.

The shared anonymization model may be global. The global anonymization model may be formed based on external reference data and the shared anonymization model.

The shared anonymization model may be based on a first global anonymization model.

Advantageously, a subset of all local nodes may employ a shared anonymization model that is based on the global anonymization model for forming their own local anonymization models such that the subset of local nodes allow sharing the information describing their second anonymization models with greater trust for forming a second shared anonymization model and then share resulting information describing the second shared anonymization model for forming a second global anonymization model. In effect, an intermediate layer of anonymization model refinement may be provided for separating the information describing the individual local nodes. Notably, the information describing the anonymization model is not by default sensitive information, but merely descriptive of how the sensitive information would be anonymized. Yet, it can be envisioned that some small business or health data organizations might like to pool information describing their local anonymization models with select others before any information would flow to the global model.

The forming of the first local anonymization model may be based on an initial shared anonymization model. The initial shared anonymization model may be the first shared anonymization model. The initial shared anonymization model may be a default shared anonymization model that defines basic mechanisms, parameters, criteria, and transformation rules for anonymizing data.

The sharing of the information describing the second local or shared anonymization model may be federated. The sharing of the information describing the second local or shared anonymization model may comprise providing that information to an orchestrating node.

The sharing of the information describing the second local or shared anonymization model may be swarm oriented. The sharing of the information describing the second local or shared anonymization model may comprise providing that information to a consensus-based decision process by a swarm of peer nodes for the forming of the second shared or global anonymization model. The sharing of the information describing the second local or shared anonymization model may comprise providing that information to a ledger such as a block chain accessible to a plurality of members of a swarm of peer nodes.

The method may be a computer-implemented method. The method may be an automatic method.

According to a second example aspect there is provided a local node for multi-party data anonymization with a plurality of external nodes, comprising
means for forming a first local anonymization model based on a first set of local data available to the local node at a first time;
means for obtaining a first shared anonymization model;
means for adapting the first local anonymization model based on the first shared anonymization model; and
means for subjecting the adapting of the first local anonymization model to verifying that the adapted first local anonymization model passes a risk assessment.

The risk assessment may comprise or be a re-identification risk assessment.

According to a third example aspect, there is provided a computer program comprising computer executable program code for causing an apparatus to perform, when executing the program code, the method of the first example aspect.

According to a fourth example aspect there is provided a computer program product comprising a non-transitory computer readable medium having the computer program of the third example aspect stored thereon.

According to a fifth example aspect there is provided an apparatus comprising at least one processor and memory configured to cause the apparatus to perform the method of the first example aspect.

According to a sixth example aspect there is provided an anonymization system comprising a plurality of local nodes. The local nodes may be configured to perform the method of the first example aspect. Some or all of the local nodes may comprise the apparatus of the fifth or sixth example aspect.

The system may comprise a first group of local nodes that are configured to perform the sharing, with the external party, of information describing the second anonymization model for forming the second shared anonymization model based on at least the first shared anonymization model and the information describing the second local anonymization model.

The system may comprise a first group of local nodes that are configured to receive shared or global anonymization models without sharing the information describing the second anonymization model.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

### BRIEF DESCRIPTION OF THE FIGURES

Some example embodiments will be described with reference to the accompanying figures, in which:

FIG. 1 schematically shows a distributed anonymization system according to an example embodiment through different phases from forming local anonymization models to adapting same using a shared anonymization model, based on federated learning;

FIG. 2 schematically shows a distributed anonymization system according to an example embodiment in updating local and shared anonymization models, based on federated learning;

FIG. 3 schematically shows a distributed anonymization system according to an example embodiment through different phases from forming local anonymization models to adapting same using a shared anonymization model, based on swarm learning;

FIG. 4 schematically shows a distributed anonymization system according to an example embodiment in updating local and shared anonymization models, based on swarm learning;

FIG. 5 shows a block diagram of an apparatus according to an example embodiment; and

FIG. 6A shows a flow chart according to an example embodiment; and

FIGS. 6B and 6C show further optional steps, any one or more of which may be further comprised by the process of FIG. 6A.

### DETAILED DESCRIPTION

In the following description, like reference signs denote like elements or steps.

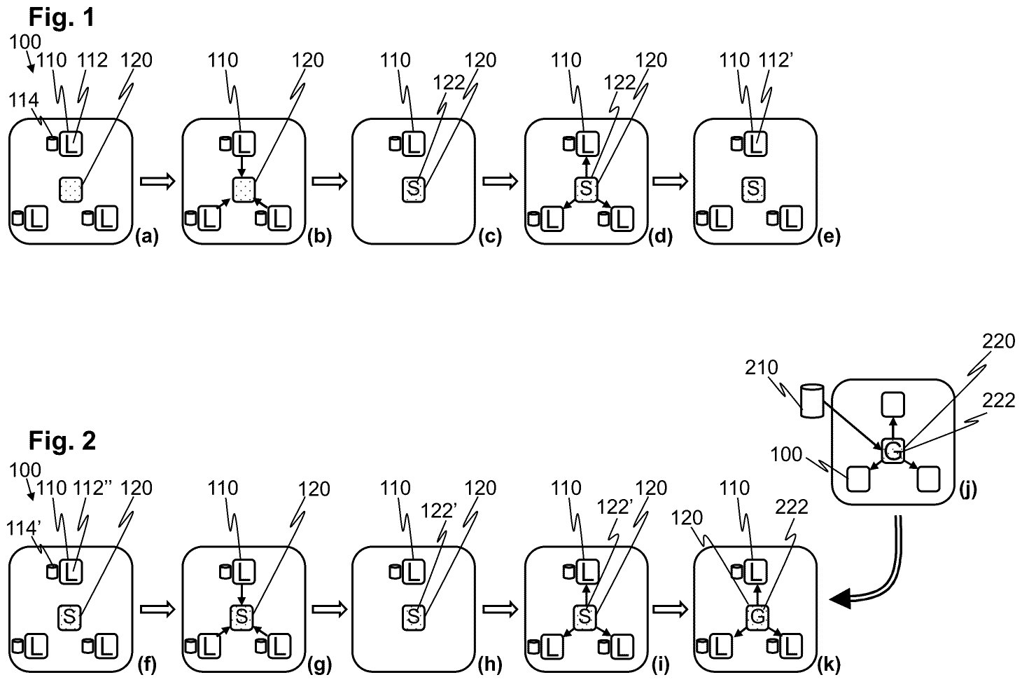

FIG. 1 schematically shows a distributed anonymization system 100 according to an example embodiment through different phases from forming local anonymization models to adapting same using a shared anonymization model, based on federated learning. FIG. 1 illustrates a plurality of local nodes 110 that each have their own local data 114, e.g., stored in their own data banks. In an example embodiment, the development of the shared anonymization model is controlled by a centralized party, here referred to as an orchestrator 120.

In an example embodiment, the local nodes 110 are devices that run according to computer program code, hardwired logic, or both, so that the processing can be performed automatically without ever revealing any source data to human beings. Moreover, the local nodes 110 are capable of performing real-time computation at a pace that prohibits manual operation. Likewise, other data processing entities of this disclosure are automated devices, that operate by computer program code, hardwired logic, or both, at a pace that would be impossible to provide manually. In particular, some transformations or conversions can be iterative so as to ensure that various risks such as reidentification mitigation, which may require enormous calculation for large data sets. If such calculation were to be made manually even by a large group of people, the source data set could already have changed so preventing manual calculation no matter how large a group of people would be calculating. Also computation distribution and scheduling of manual would demand more processing and at a higher pace than would be humanly possible. In particular, factors such as these would render any manual or pen-and-paper execution inoperable:
(i) automatic anonymization and risk-assessment computations executed without exposing source data to human operators;
(ii) execution within trusted execution environments (optionally with remote attestation);
(iii) iterative, non-trivial numeric procedures (e.g., evaluation of risk metrics and constrained optimization of anonymization parameters);
(iv) operation over high-volume, high-dimensional data, including live, continuously evolving datasets;
(v) processing at machine speeds under streaming and latency constraints; and
(vi) exchange of compact model summaries (parameters and metadata) rather than raw records.

In a first phase (a) of FIG. 1, each local node 110 forms a first local anonymization model 112 based on a first set of local data 114 available to the local node 110 at a first time.

In a second phase (b), the orchestrator 120 obtains the first local anonymization models 112 from the local nodes 110. In an example embodiment, the orchestrator 120 obtains information describing the first anonymization models. In an example embodiment, the information describing any anonymization model further comprises information describing the data for anonymization of which the anonymization model has been formed, such as statistical characteristics.

In an example embodiment, the statistical characteristics include any one or more of the following: measures of central tendency; measures of dispersion; distribution shape; percentiles or quartiles; frequency counts or proportions; correlation or association measures; and/or aggregated summaries. In an example embodiment, the measures of central tendency comprise any one or more of a mean, median, and/or mode. In an example embodiment, the measures of dispersion comprise any one or more of a range; variance; standard deviation; and/or interquartile range. In an example embodiment, the measures of distribution shape comprise skewness and/or kurtosis. In an example embodiment, the correlation or association measures comprise correlation coefficients for numeric variables. In an example embodiment, the correlation coefficients comprise Pearson coefficients. In an example embodiment, the correlation coefficients comprise Spearman coefficients for numeric variables. In an example embodiment, the correlation coefficients comprise chi-square tests for categorical variables.

In an example embodiment, the information describing any anonymization model comprises synthetic data. In an example embodiment, the synthetic data is formed to replicate risks of actual data based on which the anonymization model is formed, but with made up information.

In an example embodiment, the data based on which any anonymization model is formed comprises unstructured data such as text. In an example embodiment, the unstructured data is anonymized using pseudonymization, in which an identifier is reversibly represented by another identifier. In an example embodiment, the unstructured data is anonymized using lossy conversion such as generalization. In an example embodiment, in case of hierarchical data, the lossy conversion comprises deletion of lower level classification information. In an example embodiment, the unstructured data is anonymized using redaction in which some information is wiped substituted with given characters or wiped out entirely.

In an example embodiment, the synthetic data entirely substitutes actual data with which the anonymization model has been formed. In an example embodiment, the synthetic data comprises or is unstructured, such as textual data. In an example embodiment, the synthetic data comprises or is structured, such as tabular data.

In a third phase (c), the orchestrator 120 forms a first shared anonymization model 122 based on the obtained first local anonymization models 112. In an example embodiment, the first shared anonymization model is based on the information describing the first anonymization model. In an example embodiment, the first shared anonymization model is based on the information describing the first anonymization model, and information describing one or more other anonymization models by respective one of more other local nodes.

In a fourth phase (d), the orchestrator 120 provides the local nodes 110 with the first shared anonymization model 122. In an example embodiment, the orchestrator 120 spares bandwidth by submitting information describing the first shared anonymization model 122 instead of sending the first shared anonymization model 122 as such. For example, the information describing the first shared anonymization model 122 may indicate differences over an anonymization model previously known by the local node 110. In an example embodiment, previously known anonymization model is a reference anonymization model.

In an example embodiment, previously known anonymization model is the first local anonymization model of the local node in question. In this case, the orchestrator determines the information describing the first anonymization model 122 separately for each node that has a unique local anonymization model 112.

In a fifth phase (e), each local node 110 adapts the first local anonymization model 112 into a second local anonymized model 112′ based on the first shared anonymization model 122. In result, all the local nodes 110 that participate in this process should have the first shared anonymization model 122 as their second anonymization model 112′.

Advantageously, anonymization by different local nodes may be harmonized by providing a first shared anonymization model for use by different local nodes that may then adapt their own first local anonymization models.

In an example embodiment, the adapting of the local anonymization model is subjected to verifying that the adapted local anonymization model passes the risk assessment.

In an example embodiment, the local anonymization models define how data shall be anonymized by the local nodes. In an example embodiment, the local anonymization model defines mechanisms for anonymizing data according to the local anonymization model. In an example embodiment, the local anonymization model is deterministic, optionally including use of randomization.

FIG. 2 schematically shows a distributed anonymization system according to an example embodiment in updating local and shared anonymization models, based on federated learning. In FIG. 1, the local nodes 110 were provided with a first shared anonymization model 122 so that the local nodes 110 could acquire same second local anonymization model. However, in an example embodiment, the local nodes 110 can further develop their first anonymization models in order to account for changes in the local data, such as addition of further data or correcting earlier data. FIG. 2 illustrates a way to allow the local nodes 110 to perform this, and to again collaborate to form a second shared anonymization model through which the local nodes 110 can then again harmonize their local anonymization models. Let us next go through FIG. 2, with a clarifying comment, that the phases are labeled sequentially for the sake of simple referencing rather than with an intent to require that all these phases be performed and necessarily in the sequential order as presented here. For example, some phases could be combined or omitted altogether, where feasible. It should also be appreciated it is possible to implement a local node that acquires and uses the shared anonymization model without contributing to its development at all. Likewise, some local nodes may join the system at a later stage and effectively skip past developments of the shared anonymization model, for example.

In a sixth phase (f) of FIG. 1, each local nodes 110 form a third local anonymization model 112″ based on the second local anonymization model 112′ and a second set of local data 114′ available to the local node 110 at a second time.

In a seventh phase (g), the orchestrator 120 obtains the third local anonymization models 112″ from the local nodes 110. In an example embodiment, the orchestrator 120 polls the local nodes 110 for any changes in their second anonymization models 112′ and obtains the third anonymization models 112″ in response to identifying that there are changes in the (second) local anonymization models. In an example embodiment, orchestrator 120 requests for new local anonymization models periodically. In an example embodiment, the local nodes 110 are configured to inform the orchestrator 120 of changes in their local anonymization models.

In an eighth phase (h), the orchestrator 120 forms a second shared anonymization model 122′ based on the obtained third local anonymization models 112″, e.g., similarly to the third phase (c).

Advantageously, some or all local nodes may further develop the shared anonymization model into a new version of the shared anonymization model, for example, to better take into account increased data available to local nodes such that earlier risks of re-identification have been mitigated by increased number of individuals sharing given quasi-identifiers.

In a ninth phase (i), the orchestrator 120 provides the local nodes 110 with the second shared anonymization model 122′.

In an example embodiment, the orchestrator 120 spares bandwidth by submitting information describing the shared anonymization model instead of sending the shared anonymization model as such. For example, the information describing the shared anonymization model may indicate differences over an anonymization model previously known by the local node 110. In an example embodiment, previously known anonymization model is a reference anonymization model. In an example embodiment, previously known anonymization model is a previously identified local anonymization model of the local node in question. In this case, the orchestrator determines the information describing the shared anonymization model separately for each node that has a unique local anonymization model as a reference. Notice: reference was not made in this paragraph for the particular versions of the anonymization models in sake of simplicity: the same applies to various versions (first, second, subsequent ones) alike.

In a tenth phase (j), a global controller 220 forms a global anonymization model 222 based on external data 210 which may comprise some or all of the local data acquired by the local nodes 110 and/or other data. The global controller shares the global anonymization model 222 to the distributed anonymization system 100, for use of the orchestrator 120. In an example embodiment, the external data 210 comprises information describing the local data acquired by the local nodes. In an example embodiment, that information describing the local data comprises statistical characteristics, such as those described in the foregoing.

In an eleventh phase (k), the orchestrator 120 adapts the global anonymization model 222 and distributes the global anonymization model 222 to the local nodes 110, which then adopts that as their new local anonymization model.

In an example embodiment, local anonymization model defines how data shall be anonymized by the local node. In an example embodiment, local anonymization model defines a mechanism for anonymizing data according to the local anonymization model. In an example embodiment, the mechanism defines how the anonymization is performed at a local node. In an example embodiment, the mechanism comprises any of parameters, privacy criteria, and/or transformation rules.

In an example embodiment, shared anonymization model defines how data shall be anonymized by a plurality of local nodes after they adopt the shared anonymization model.

In an example embodiment, shared anonymization model defines a mechanism for anonymizing data according to the shared anonymization model.

In an example embodiment, earlier versions of the shared anonymization model are maintained. In an example embodiment, anonymized datasets are described with a version of a shared anonymization model that has been used for improving interoperability with other nodes.

In an example embodiment, the shared anonymization model aggregates anonymization weights and parameters obtained from a plurality of local nodes.

In an example embodiment, the sharing of the information describing the second local or shared anonymization model is federated, as exemplified by FIGS. 1 and 2.

In an example embodiment, the sharing of the information describing the second local or shared anonymization model is swarm oriented. In an example embodiment, the sharing of the information describing the second local or shared anonymization model comprises providing that information to a consensus-based decision process by a swarm of peer nodes for the forming of the second shared or global anonymization model. In an example embodiment, the sharing of the information describing the second local or shared anonymization model comprises providing that information to a block chain accessible to a plurality of members of a swarm of peer nodes.

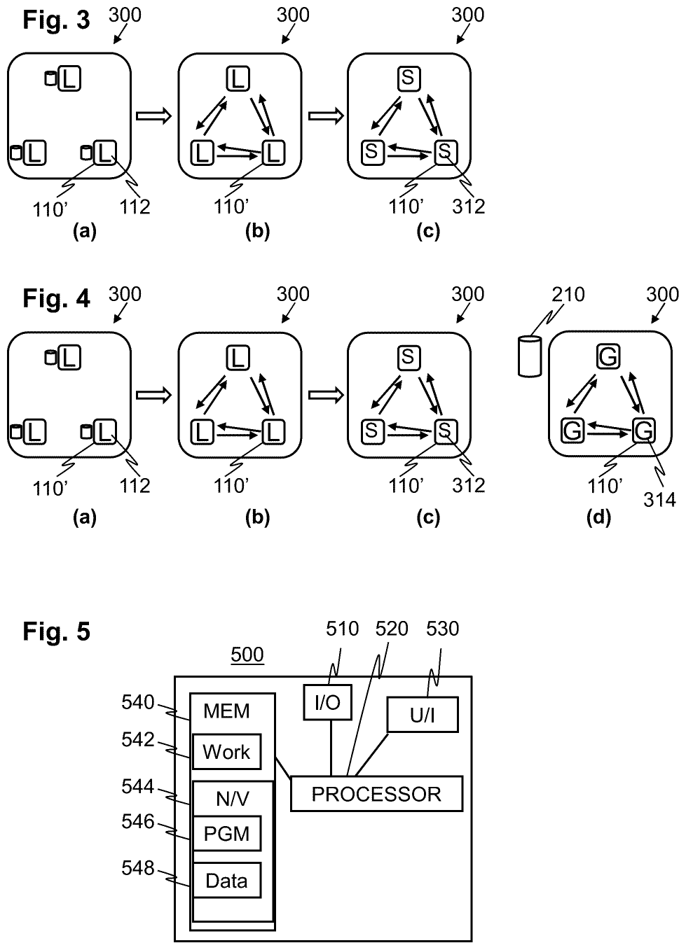

FIGS. 3 and 4 illustrate the swarm oriented sharing of information describing the shared anonymization model of a local node.

In a first phase (a), the local nodes 110 form or adapt their local anonymization models 112.

In a second phase (b), the local nodes 110 exchange their local anonymization models 112 or information describing them.

In a third phase (c), the local nodes 110 then use some consensus based decision making process to determine a shared anonymization model 314 that will subsequently be used by the local nodes as their new local anonymization model 112.

FIG. 4 illustrates an optional fourth phase in which the local nodes 110 make use of the external data 210 and further collaborate forming a global anonymization model 316. In an example embodiment, the local nodes 110 distribute this global anonymization model for use by others, e.g., by other swarm based local nodes 110′ and/or federated local nodes 110.

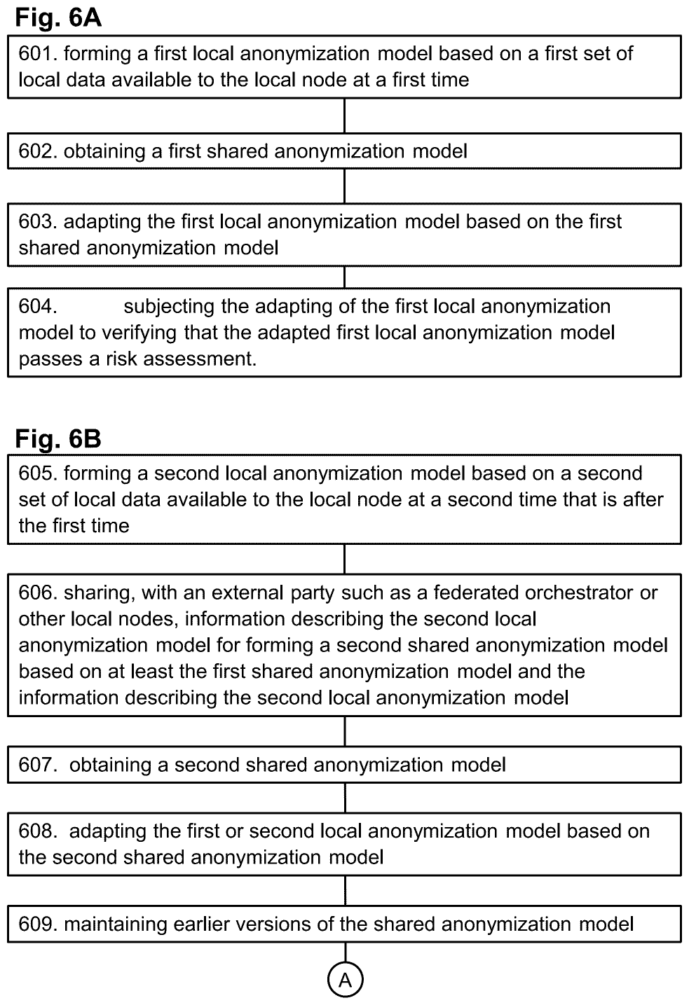

FIG. 5 shows a block diagram of an apparatus 500 according to an example embodiment.

The apparatus 500 comprises a communication interface 510; a processor 520; a user interface 530; and a memory 540.

The communication interface 510 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the apparatus 500 or provided as a part of an adapter, card or the like, which is attachable to the apparatus 500. The communication interface 510 may support one or more different communication technologies. The apparatus 500 may also or alternatively comprise more than one of the communication interfaces 510.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the apparatus 500, e.g., via a keyboard; graphical user interface shown on the display of the apparatus 500; speech recognition circuitry; or an accessory device; such as a headset; and for providing output to the user via, e.g., a graphical user interface or a loudspeaker.

The memory 540 comprises a work memory 542 and a persistent memory 544 configured to store computer program code 546 and data 548. The memory 540 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The apparatus 500 may comprise a plurality of the memories 540. The memory 540 may be constructed as a part of the apparatus 500 or as an attachment to be inserted into a slot; port; or the like of the apparatus 500 by a user or by another person or by a robot. The memory 540 may serve the sole purpose of storing data, or be constructed as a part of an apparatus 500 serving other purposes, such as processing data.

A skilled person appreciates that in addition to the elements shown in FIG. 5, the apparatus 500 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the apparatus 500 may comprise a disposable or rechargeable battery (not shown) for powering the apparatus 500 if external power supply is not available.

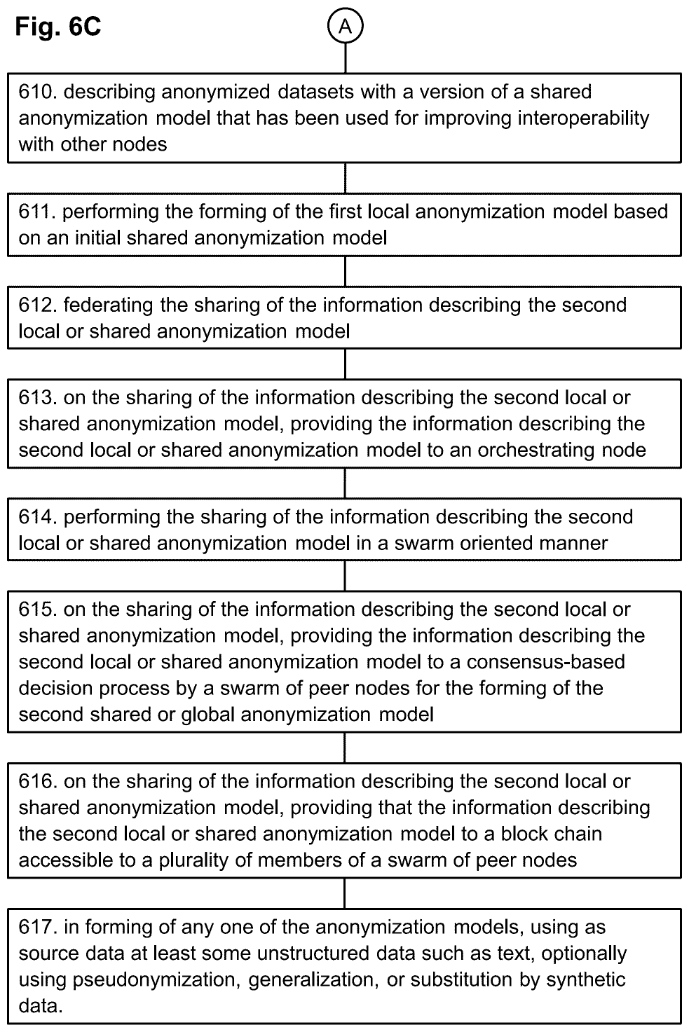

FIG. 6A shows a flow chart according to an example embodiment. FIG. 6A illustrates a process comprising various possible steps including some optional steps while also further steps can be included and/or some of the steps can be performed more than once:
601. forming a first local anonymization model based on a first set of local data available to the local node at a first time;
602. obtaining a first shared anonymization model;
603. adapting the first local anonymization model based on the first shared anonymization model; and
604. subjecting the adapting of the first local anonymization model to verifying that the adapted first local anonymization model passes a risk assessment.

FIGS. 6B and 6C show further optional steps any one or more of which may be further comprised by the process of FIG. 6A:
605. forming a second local anonymization model based on a second set of local data available to the local node at a second time that is after the first time;
606. sharing, with an external party such as a federated orchestrator or other local nodes, information describing the second local anonymization model for forming a second shared anonymization model based on at least the first shared anonymization model and the information describing the second local anonymization model;
607. obtaining a second shared anonymization model;
608. adapting the first or second local anonymization model based on the second shared anonymization model;
609. maintaining earlier versions of the shared anonymization model;
610. describing anonymized datasets with a version of a shared anonymization model that has been used for improving interoperability with other nodes;
611. performing the forming of the first local anonymization model based on an initial shared anonymization model;
612. federating the sharing of the information describing the second local or shared anonymization model;
613. on the sharing of the information describing the second local or shared anonymization model, providing the information describing the second local or shared anonymization model to an orchestrating node;
614. performing the sharing of the information describing the second local or shared anonymization model in a swarm oriented manner;
615. on the sharing of the information describing the second local or shared anonymization model, providing the information describing the second local or shared anonymization model to a consensus-based decision process by a swarm of peer nodes for the forming of the second shared or global anonymization model;
616. on the sharing of the information describing the second local or shared anonymization model, providing that the information describing the second local or shared anonymization model to a block chain accessible to a plurality of members of a swarm of peer nodes. The swarm of peer nodes may be different local nodes;
617. in forming of any one of the anonymization models, using as source data at least some unstructured data such as text, optionally using pseudonymization, generalization, or substitution by synthetic data.

As a comparative example, an open source large language model could be fine-tuned for use as the local anonymization model, whereas in an example embodiment, the local anonymization model may be based on parameters derived using a large international registry that is then fine-tuned for the needs of the swarm/federation.

The local and shared anonymization models may avoid challenges caused by using distributed data sources across varying data schemas normalizing a data schema that is employed by the anonymization models. In an example embodiment, the data schema refers to a structure that defines the organization of data within databases, including tables, fields, and relationships. For example, a data schema for a customer database may include tables for customer details, orders, and payments.

Advantageously, at least some example embodiments may enable combining updates from local anonymization models with the shared anonymization model iteratively (in case of federated learning) or that nodes reach a consensus, e.g., through blockchain system, to update the shared anonymization model.

In an example embodiment, each node processes its local datasets by
defining data types of variables within each local dataset,
identifying quasi-identifiers,
assessing re-identification sensitivity for individual variables and subsets
handling missing data
supporting various data transformations, such as generalization and synthetic data generation
optimizing the selection of quasi-identifiers, use of synthesized data, and choice of data transformations to minimize information loss and enhance privacy metrics
training the local anonymization model based on the optimized parameters for ensuring robust anonymization
distributed anonymity verification step
updating gradients or weights from local anonymization model at each node either with a central/shared anonymization model (in case of federated learning) or broadcast updates to a consensus decision making, such as a blockchain system, and validating the updates to reach a consensus to update the shared anonymization model (in case of swarm learning)
re-training with any additional/new data by using the updated central/shared/global model (while treating it as a local anonymization model) for the next round of local training Data types of variables may be based on data/variable nature and usage, e.g., categorical (gender, race), numerical (age, salary), ordinal (education level, satisfaction rating) and/or longitudinal (time-based), etc.

Quasi-identifiers may refer to variables which are not unique identifiers themselves, but could be combined with other quasi-identifying variables to create a unique identifier and identify/re-identify individuals.

Re-identification risk may refer to a risk or potential of anonymized or de-identified data being re-identified. For example, a dataset containing zip code and birthdate might be sensitive to re-identification.

Handling of missing data: the missing data may be a value not observed or a nonsensical combination. When data are missing completely at random, no bias is introduced, requiring no special treatment. In an example embodiment, applicable handling methods include imputation methods like mean substitution, regression, or using algorithms that handle missing data directly.

In an example embodiment, the data transformations include generalization and/or synthetic data generation, such as:
Suppression: sensitive data or values are deleted at the cell level, or whole variables or records are removed from the table
Generalization: approach which seeks to provide concealment of sensitive values by binning continuous variables, reducing accuracy of time/date stamps, reducing specificity of diagnosis codes, etc.
Noise addition: different methods of adding noise to continuous sensitive numerical variables.
Data swapping: values of sensitive variables are swapped between records while maintaining statistical properties
Synthetic data: used to replace original set of (suppressed) tuples with look-alike values while preserving statistical properties of the original data values or to impute missing values.

In an example embodiment, participants of the federation or swarm agree (e.g., form a union or intersection) on variables which should be considered as quasi-identifying. In an example embodiment, the such variables are characterised by
Uniqueness: Attributes that are unique to groups of individuals.
Availability: Attributes that are commonly available in other datasets.
Sensitivity: Attributes that, if combined, can lead to identification.

Example: Federated node A: data of one gender only (gender is NOT a quasi-identifier at this node), Federated node B: mixed gender data (gender IS a quasi-identifier at this node). Looking at a random record, ‘gender’ can trace back the parent node, so ‘gender’ would be a quasi-identifier at a global level as well.

The anonymization models have various advantageous uses also including generation of synthesized data. User(s) of the federation or swarm might use synthetic data for use cases such as training machine learning models, software testing, data/knowledge sharing, imputation of missing data.

In this context, minimizing of information loss may refer to finding a local minimum, not necessarily the least possible information loss. For example, the minimizing of information loss may be done using as input: data, privacy criteria, quality/utility criteria, priorities in the data, and providing as output multiple possible anonymization solutions, wherein an optimized solution fulfills privacy criteria and attempts to maximize anonymized data quality/utility (and minimize information loss).

In an example embodiment, the optimizing of the anonymization parameters locally and by agreement with others or using the federated model leads to the shared anonymization model. In an example embodiment, in a process of agreeing on the data privacy criteria, the local nodes can agree or receive a federated agreement on priorities and other data utility and quality related preferences/parameters.

In the context of preceding disclosure, robust anonymization ensures that anonymization withstands (expected) attempts at re-identification and maintains data utility.

In an example embodiment, distributed anonymity verification step involves that anonymity verification is done so that
First verification is done at node level (local nodes)
Federation: nodes share the results with the central node/orchestrator
Swarm: nodes share results through a ledger or some other mechanism
Individual results (proofs) are combined as a shared/global proof of anonymity of the dataset

In the context of the preceding disclosure, the gradients and weights are related to a model trained by a customer for a customer specific use case.

Data transformation rules or solutions may refer to the anonymization parameters.

In the federated systems, anonymization parameters are shared with the central node/orchestrator. In a swarm, the anonymization parameters are shared by a group of nodes in a consensus method and optionally stored in a ledger that may be stored in a blockchain.

In an example embodiment, the quasi identifiers could be different at different local nodes based on the variables and their distribution in the (local) node data. Based on the distribution of variables, the local anonymization parameters might also differ. The parameters may vary but the final transformation rules used after building the common or consensus model should be the same for harmonization, so that shared transformation rules are used across the entire decentralized multi-party anonymization system.

In an example embodiment, re-training with new data involves a coordinated process that ensures the privacy of individual local nodes while leveraging the shared knowledge of the shared or global model. For example:
Each node processes its local data and learns the parameters.
The orchestrator (Federation) uses versioning the parameters used to build the shared anonymization model and its transformation rules
In the swarm, the ledger may be used for version control of the parameters used to update the anonymization model and rules
Each node incorporates the updated anonymization model and its transformation rules.

Examples include birthdate, gender, and postal code. Any of the afore described methods, method steps, or combinations thereof, may be controlled or performed using hardware; software; firmware; or any combination thereof. The software and/or hardware may be local; distributed; centralized; or any combination thereof. Moreover, any form of computing, including computational intelligence, may be used for controlling or performing any of the afore-described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is, however, clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method in a local node for a multi-party data anonymization system comprising the local node and a plurality of external nodes, comprising
forming a first local anonymization model based on a first set of local data available to the local node at a first time;
obtaining a first shared anonymization model; and
adapting the first local anonymization model based on the first shared anonymization model;
wherein the adapting of the first local anonymization model is subjected to verifying that the adapted first local anonymization model passes a risk assessment.

2. The method of claim 1, further comprising
forming a second local anonymization model based on a second set of local data available to the local node at a second time that is after the first time; and
sharing, with an external party such as a federated orchestrator or other local nodes, information describing the second local anonymization model for forming a second shared anonymization model based on at least the first shared anonymization model and the information describing the second local anonymization model.

3. The method of claim 1, further comprising
obtaining a second shared anonymization model; and
adapting a current local anonymization model of the local node based on the second shared anonymization model.

4. The method of claim 1, further comprising
maintaining earlier versions of the shared anonymization model; and
describing anonymized datasets with a version of a shared anonymization model that has been used for improving interoperability with other nodes.

5. The method of claim 1, further comprising performing the forming of the first local anonymization model based on an initial shared anonymization model.

6. The method of claim 1, further comprising federating the sharing of the information describing the second local or shared anonymization model.

7. The method of claim 6, further comprising, on the sharing of the information describing the second local or shared anonymization model, providing the information describing the second local or shared anonymization model to an orchestrating node.

8. The method of claim 1, further comprising performing the sharing of the information describing the second local or shared anonymization model in a swarm oriented manner.

9. The method of claim 8, further comprising on the sharing of the information describing the second local or shared anonymization model, providing the information describing the second local or shared anonymization model to a consensus-based decision process by a swarm of peer nodes for the forming of the second shared or global anonymization model.

10. The method of claim 9, further comprising on the sharing of the information describing the second local or shared anonymization model, providing that the information describing the second local or shared anonymization model to a ledger such as a block chain accessible to a plurality of members of a swarm of peer nodes.

11. The method of claim 1, further comprising, in the forming of the first local anonymization model, when using as source data at least some unstructured data.

12. The method of claim 1, further comprising, using pseudonymization in the forming of the first local anonymization model, when using as source data at least some unstructured data.

13. The method of claim 1, further comprising, using generalization in the forming of the first local anonymization model, when using as source data at least some unstructured data.

14. The method of claim 1, further comprising, substitution by synthetic data in the forming of the first local anonymization model, when using as source data at least some unstructured data.

15. An apparatus comprising at least one processor and memory configured to cause the apparatus to perform the method of claim 1.

16. A computer program comprising computer executable program code for causing an apparatus to perform, when executing the program code, the method of claim 1.

17. A system comprising
the apparatus of claim 15 configured to operate a local node; and
the orchestrator.
